(19) United States
(12) Patent Application Publication
(10) Pub. No.: US 2026/0147231 A1
(43) Pub. Date: May 28, 2026

(54) WAVEGUIDE HEATER

(71) Applicant: SMART PHOTONICS HOLDING B.V., Eindhoven (NL)

(72) Inventors: Alonso Jesús MILLÁN-MEJÍA, Eindhoven (NL); Guilherme SOMBRIO, Eindhoven (NL)

(21) Appl. No.: 19/405,029

(22) Filed: Dec. 1, 2025

Related U.S. Application Data
(63) Continuation of application No. PCT/EP2024/064815, filed on May 29, 2024.

(30) Foreign Application Priority Data
Jun. 2, 2023 (GB) 2308235.7

(51) Int. Cl. G02F 1/01; G02B 6/12; G02B 6/132; H05B 3/28

(52) U.S. Cl. CPC G02F 1/0147; G02B 6/12007; G02B 6/132; G02F 1/011; H05B 3/283; G02F 2203/01; G02F 2203/50

(57) ABSTRACT

A structure comprising a substrate, a waveguide, a layer, and a heating element. The waveguide has a first thermal conductivity, and a light propagation axis. The layer has a second thermal conductivity lower than the first thermal conductivity. The heating element is operable to heat the waveguide and modify a refractive index of the waveguide. A portion of the heating element, in a cross-sectional plane perpendicular to the light propagation axis, is located between the waveguide and the substrate, and is separated from the substrate by the layer.

### CROSS-REFERENCE TO RELATED APPLICATIONS

This application is a continuation under 35 U.S.C. § 120 of International Application No. PCT/EP2024/064815, filed May 29, 2024, which claims priority to United Kingdom Application No. GB 2308235.7, filed Jun. 2, 2023, under 35 U.S.C. § 119(a). Each of the above-referenced patent applications is incorporated by reference in its entirety.

### BACKGROUND

Heating elements can be provided to control optical properties of waveguides, for example in photonic integrated circuits. For example, a heating element may be used to modulate the heat of a waveguide in order to modify the refractive index of the waveguide such that the waveguide functions as a phase shifter. It is desirable to improve heating elements.

### BRIEF DESCRIPTION OF THE DRAWINGS

FIG. 1a illustrates schematically a cross-sectional view of a structure forming part of a photonic integrated circuit (PIC) according to first examples.

FIG. 1b illustrates schematically a top-down view of the structure according to the first examples.

FIG. 2a illustrates schematically a cross-sectional view of the structure according to the first examples.

FIG. 2b illustrates schematically a top-down view of the structure according to the first examples.

FIG. 3 is a flow diagram illustrating a method of fabricating a structure according to examples.

FIGS. 4a-e illustrate schematically a method of fabricating a structure according to the first examples.

FIG. 5 illustrates a cross-sectional view of the structure according to the first examples.

FIGS. 6a-d illustrate schematically a cross-sectional view and top-down view of a structure according to second examples.

### DETAILED DESCRIPTION

Examples described herein relate to a structure, for example for a photonic integrated circuit (PIC). More specifically, the examples described herein relate to a structure comprising a waveguide and a heating element operable to heat the waveguide. The waveguide has a refractive index which is dependent on the temperature of the waveguide. The heating element, in heating the waveguide, is operable to modify the refractive index of the waveguide. The phase of light within the waveguide can be controlled by controlling the refractive index of the waveguide and thereby allowing an effective optical path length of the waveguide to be changed. The waveguide can therefore function as an optical phase shifter.

Such a structure may also be provided as a standalone component and does not necessarily form part of a PIC, for example. The structure may be used in a semiconductor laser diode, for example, which emits light into free space and does not necessarily share a substrate with other photonic components, for example.

In general, the structure described herein can be fabricated as part of a photonic integrated circuit which comprises at least one photonic component, or as at least a portion of a standalone photonic component. The skilled person will appreciate that the precise material composition of the structure can vary between examples and can include, for example, electro-optic crystals, polymers, and semiconductor materials, and other materials which are used to form integrated photonic components.

In examples described herein, the heating element is provided between the waveguide and a substrate, for example the wafer substrate of the PIC. The heating element is separated from the substrate by a layer. The waveguide has a first thermal conductivity, and the layer has a second thermal conductivity. The second thermal conductivity is lower than the first thermal conductivity. In this way, heat from the heating element is more efficiently absorbed by the waveguide, and less efficiently absorbed by, for example, the substrate. For example, heat may flow towards the waveguide, improving heat confinement of the structure. This improves the power efficiency of the heating element.

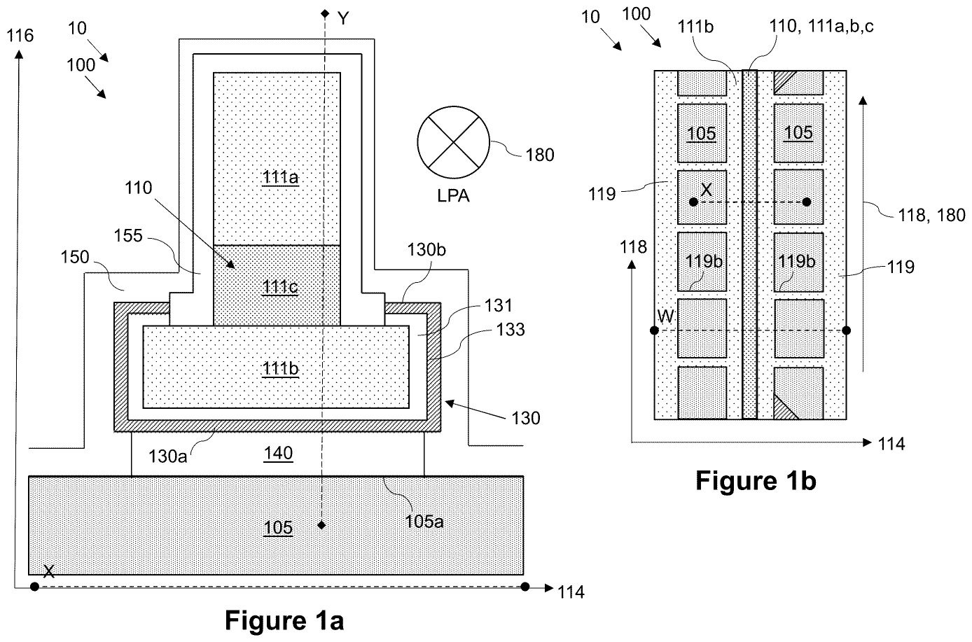

FIG. 1a illustrates schematically a cross-sectional view of a structure 100 of first examples, the structure 100 being for a PIC 10. FIG. 1b illustrates schematically a plan-view of the structure 100 of first examples.

The cross-sectional view is in a plane perpendicular to a light propagation axis LPA which, in FIG. 1a, is into the page, as indicated by the symbol 180. The structure 100 in a cross-sectional view can be described relative to a first axis 116 and a second axis 116. The first axis 116 is perpendicular to the second axis 114. The first axis can be considered a vertical axis 116 and the second axis 114 can be considered a horizontal axis 114 in the orientation shown in FIG. 1a. In the plan-view of FIG. 1b, the structure 100 can be described relative to the horizontal axis 114 and a third axis 118. The third axis 118 is substantially the same as the light propagation axis 180, and can be considered a length axis 118. The skilled person will understand that the first to third axes 114, 116, 118, which may be referred to collectively as reference axes 114, 116, 118, define a local reference frame and that the positional description of components are implicitly with respect to this reference frame, unless explicitly stated otherwise. Furthermore, the local reference frame can be mapped to some other reference frame. For example, a first component being described as “above” a second component with regard to the reference axes 114, 116, 118 is still valid even if the PIC 10 or structure 100 is rotated in some other reference frame.

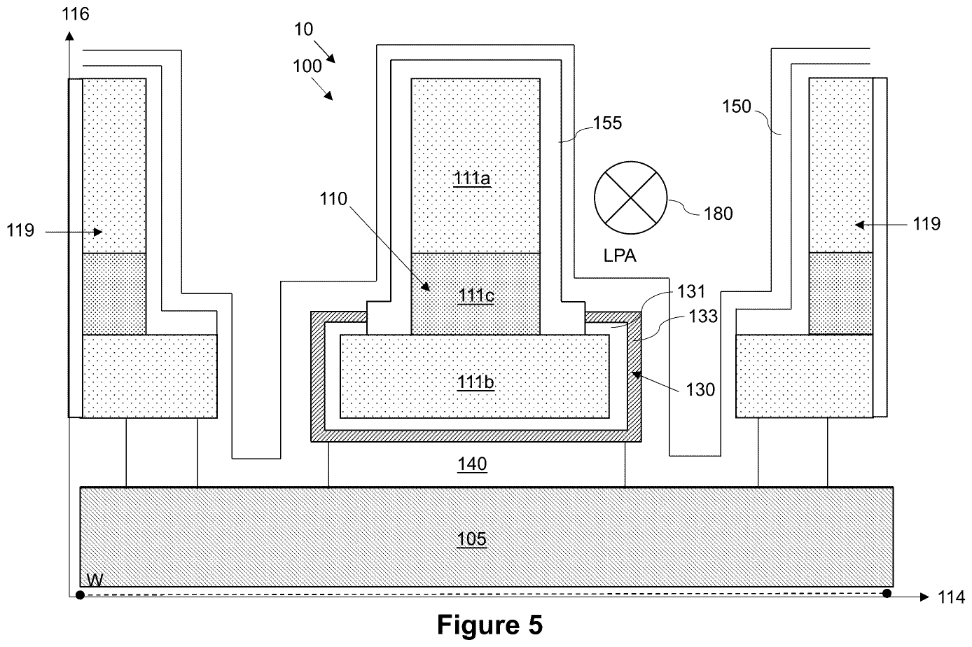

The cross-sectional view of FIG. 1a is taken along indicative line X of FIG. 1b, as indicated on the horizontal axis 114 in FIG. 1a. A cross-sectional view of the structure 100 spanning the whole width of the PIC 10, that is along indicative line W of FIG. 1b, is illustrated in FIG. 5 and described later.

The structure 100 comprises a substrate 105. In the first examples, the substrate 105 is a substrate plane of the PIC 10. In other words, the substrate 10 is a wafer substrate upon which the PIC 10 is formed. The substrate 105 is substantially planar and extends substantially in the horizontal plane, that is, an upper surface 105a of the substrate 105 is substantially parallel with the horizontal axis 114. The substrate 105 can be considered to form a base for the structure 100, such that other components described hereafter can be considered to be above the substrate 105, with respect to the vertical axis 116.

The structure 100 comprises a waveguide 110. In the first examples, the waveguide 110 comprises a core layer 111c, a first cladding layer 111a and a second cladding layer 111b. In the cross-sectional plane of FIG. 1a, the core layer 111c is between and in contact with the first cladding layer 111a and the second cladding layer 111b. With respect to the vertical axis 116, the waveguide 110 can be considered to be above the substrate 105. Similarly, the core layer 111c can be considered to be below the first cladding layer 111a and above the second cladding layer 111b.

The waveguide 110 is separated from the substrate 105. In the first examples, the waveguide 110 can be considered to be a suspended waveguide. That is, in the cross-section of FIG. 1a, the waveguide 110 is not in contact with the substrate 105. Instead, the waveguide 110 is intermittently connected to supporting structures 119 (not shown in FIG. 1a, see FIG. 1b and FIG. 5) along a length of the structure 100 by supporting segments 119b, shown in FIG. 1b. Those skilled in the art will be familiar with the suspended waveguide structure described here and the fabrication thereof.

The structure 100 comprises a heating element 130. In the first examples, the heating element 130 comprises a dielectric layer 131 and a metal layer 133. The dielectric layer 131 is in contact with the waveguide 110, specifically the second cladding layer 111b of the waveguide 110. The metal layer 133 is separated from the waveguide 110 by the dielectric layer 131, such that the metal layer 133 is not in contact the waveguide 110. As measured along the horizontal axis 114, the heating element 130 and waveguide 110 can each be considered to have a width, and the heating element 130 extends along a substantial portion of the width of the waveguide 110. In this example, the heating element 130 has a greater width than the waveguide 110, such that for any portion of the waveguide 110, the heating element 130 is between the waveguide 110 and the substrate 105. In general, the heating element 130 extending along a substantial portion of the width of the waveguide 110 for example means that the width of the heating element 130 is comparable to the width of the waveguide 110. For example, the width of the heating element 130 may be at least eighty percent the width of the waveguide 110.

A first portion 130a of the heating element 130 is located between the waveguide 110 and the substrate 105. With respect to the vertical axis 116, the heating element 130 can be considered to be above the substrate 105. Similarly, the waveguide 110 can be considered to be above the first portion 130a of the heating element 130. In other words, the first portion 130a of the heating element 130 can be considered to be underneath the waveguide 110, between the waveguide 110 and the substrate 105.

A second portion 130b of the heating element 130 is located, with respect to the vertical axis 116, above the first portion 130a of the heating element 130. The second portion 130b is located, with respect to the horizontal axis 114, laterally from the core layer 111c of the waveguide 110, such that, in the first examples, the second portion 130b could be considered to be next to the core layer 111c. The second cladding layer 111b of the waveguide 110 is located between the first portion 130a of the heating element 130 and the second portion 130b of the heating element 130, such that the heating element 130 can be considered to partially wrap around a portion of the waveguide 110 (in this case, a portion of the second cladding layer 111b). The first portion 130a of the heating element 130 is between the second portion 130b of the heating element 130 and the substrate 105, such that the heating element 130 can be considered to have a folded structure. In this way, a total surface area of the heating element 130 can be increased without increasing the footprint of the heating element laterally, that is relative to the horizontal axis 114.

The structure 100 comprises a layer 140, which in the first examples is an air layer 140. The air layer 140 is between the heating element 130 and the substrate 105, and in particular between the first portion 130a of the heating element 130 and the substrate 105. The air layer 140 extends substantially between the heating element 130, and in particular the first portion 130a of the heating element 130, and the substrate 105 such that the heating element 130, and in particular the first portion 130a of the heating element 130, is substantially entirely separated from the substrate 105. In general, the air layer 140 extending substantially between the heating element 130 and the substrate 104 for example means that the heating element 130 is almost entirely, or entirely, separated from the substrate 105. The heating element 130 may, in examples, comprise portions in contact with the substrate 105 but these portions are small relative to portions of the heating element 130 separated from the substrate 05 by the air layer 140. For example, in being almost entirely separated, the air layer 140 may separate eighty percent of the heating element 130 from the substrate 105. The air layer 140 can be thought of as an air gap, and in some examples may comprise a plurality of air gaps.

The structure 100 comprises a first passivation layer 150 and a second passivation layer 155. In the plan view of FIG. 1b, the first and second passivation layers 150, 155 are not shown, so as not to obscure the view of the remaining components. With respect to the vertical axis 116, the waveguide 110, heating element 130 and layer 140 are between a portion of the first passivation layer 150 and the substrate 105. Similarly, a portion of the waveguide 110, heating element 130 and layer 140 are between the second passivation layer 155 and the substrate 105. In the first examples, the second passivation layer 155 is between the first passivation layer 150 and the waveguide 110. That is, the second passivation layer 155 contacts surfaces of the waveguide 110, in this example covering surfaces of the first cladding layer 111a and the core layer 111c, and a portion of the surface of the second cladding layer 111b. Surfaces of the second passivation layer 155 which are in contact with the waveguide 110 can be considered internal surfaces of the second passivation layer 155, and accordingly external surfaces of the second passivation layer 155 are in contact with the first passivation layer 150. In other examples, only a single passivation layer 150 may be provided, or more than two passivation layers may be provided. In further examples the structure 100 may not comprise a passivation layer.

In the first examples, the air layer 140 is surrounded, in the cross-sectional plane perpendicular to the light propagation axis 180, by respective surfaces of the substrate 105, the heating element 130 and the first passivation layer 150. In other words, the air layer 140 is surrounded on a first side by the substrate 105, on a second side by the heating element 130, and on a third and a fourth side by the passivation layer 150, wherein the first side is opposite the second side and the third side is opposite the fourth side. With respect to the vertical axis 116 and the horizontal axis 114, the first side can be considered to be a bottom side, the second side to be a top side, the third side to be a left side and the fourth side to be a right side. Surrounding the air layer 140 in this manner means the air is sealed within the air layer 140.

When considered along a vertical cross-section Y which is parallel to the vertical axis 116, indicated by the line Y in FIG. 1a, the features of structure 100 according to the first examples can be considered to be arranged in the following order: the substrate 105 is at the bottom, the air layer 140 is above the substrate 105, the metal layer 133 of the heating element 130 is above the air layer 140, the dielectric layer 131 of the heating element 130 is above the metal layer 133 of the heating element 130, the second cladding layer 111b is above the dielectric layer 131 of the heating element 130, the core layer 111c of the waveguide 110 is above the second cladding layer 111b, the first cladding layer 111a is above the core layer 111c, the second passivation layer 155 is above the first cladding layer 111a, and the first passivation layer 150 is on top of the second passivation layer 155. More generally, and again with respect to the vertical axis 116, the order can be considered to be: the substrate 105 is on the bottom, the air layer 140 is above the substrate 105, the heating element is above the air layer 140, and the waveguide 110 is above the heating element 130.

Having described the structural arrangement of the structure 100, the function of the constituent components will now be described.

The waveguide 110 is for guiding light. Properties of a waveguide including, for example, its material refractive index and structural geometry, as well as properties of any surrounding cladding layers, restrict the spatial region in which light can propagate, for example the waveguide core layer 111c. The waveguide core layer 111c acts as a core layer, and has a refractive index higher than the refractive index of the surrounding first and second cladding layers 111a, 111b. The core-cladding boundary, in this case formed at surfaces of the core layer 111c which are in contact with surfaces of the cladding layers 111a, 111b, can be thought of as resulting in constructive interference of light which confines light to propagate substantially within the waveguide core 111c. The skilled person will appreciate that an evanescent field associated with light guided in the core layer 111c may exist in the cladding layers 111a, 111b. Particular optical modes of light are desired to propagate through the waveguide 110 depending on the desired application of the structure 100. The direction in which the optical modes propagate within the waveguide 110 is herein referred to as the light propagation axis 180. The light propagation axis 180 is parallel to the Poynting vector of light propagating in the waveguide 110 and the negative vector of the Poynting vector. The light propagation axis 180 is the general direction which the energy of the optical mode travels through the waveguide 110. The term “modes” as used herein for example refers to optical modes, which may be considered to be electromagnetic propagation modes. The modes of a particular waveguide are described herein as being “supported” by the waveguide.

The waveguide 110 comprises indium gallium arsenide phosphide (InGaAsP). In other examples, though, the waveguide 110 comprises or is of indium aluminium gallium arsenide (InAlGaAs). More generally, in some examples, the waveguide 110 comprises (Al)InGaAs(P). In other examples, the waveguide may comprise silicon and/or silicon nitride compositions. The elements indicated in parentheses can be interchangeable and the composition of the different elements is selected depending on the desired function. For example, the composition of Ga and As in InGaAs can be selected according to the desired bandgap. In other examples, the waveguide core layer 111c comprises a plurality of sub-layers. In some such examples, the waveguide core layer 111c comprises a (Al)InGaAs(P)/(Al)InGaAs(P) multiple quantum well structure. In some examples, the sub-layers are between 5 and 30 nanometres thick. The bandgap and therefore, as will be appreciated by those skilled in the art, the refractive index of the InGaAsP, for example, can be tuned. In some examples, the bandgap of the InGaAsP of the waveguide core layer is tuned to a wavelength of 1250 nanometres (e.g. for propagation of light of wavelength 1550 nanometres) or 1100 nanometres (e.g. for propagation of light of wavelength 1310 nanometres). In other examples, the wavelength to which the bandgap is tuned is different.

A mode supported by the waveguide 110 can be considered to have an effective refractive index which arises from a combination of the structural geometry of the waveguide 110 and the material refractive index, or indices, of the core layer 111c or the core layer and cladding layers 111c, 111a, 111b. The effective refractive index of a mode determines the rate of propagation of light through the waveguide 110 in that particular mode. By modifying the material refractive index, the effective refractive index of the mode can be modified. In general, the refractive index of a material can be modified by changing the temperature of the material. A thermo-optic coefficient of a material relates to the degree of change in refractive index of the material in response to temperature. Modifying the temperature of the waveguide 110 can thereby change the effective refractive index of a mode propagating in the waveguide 110. As those skilled in the art will appreciate, by modifying the effective refractive index of a waveguide a phase shift can be induced in light propagating through the waveguide. An optical phase shifter can be used in optical devices such as lasers, interferometers and optical switches.

The heating element 130 is operable to generate heat. In the first examples, the heating element 130 is formed from a material having a resistivity to the flow of electrical current. Specifically, the metal layer 133 is platinum in the first examples. In the first examples, an electrical potential can be placed across the metal layer 133 of the heating element 130 such that current flows through the metal layer 133. As those skilled in the art will appreciate, the metal layer 133 having a resistivity acts as a resistor when current flows through the metal layer 133, thereby generating heat.

Heat can be transferred through a material by the process of conduction of heat. A thermal conductivity of a material describes the ability of the material to conduct heat. A scalar expression for thermal conductivity k is given by expression (1):

$$q = - k ∇ T , \qquad ( 1 )$$

where q is a heat flux and VT is a temperature gradient. The thermal conductivity can be measured in watts per metre-kelvin, W/mK. The skilled person will appreciate that thermal conductivity can be related to alternative measures such as thermal resistance, thermal admittance and thermal insulance. The thermal conductivity of a particular layer referred to herein is a bulk property of the layer. For example, whilst a particular layer may comprise constituent materials having a higher thermal conductivity than the bulk layer as a whole, the thermal conductivity referred to herein is the bulk thermal conductivity unless explicitly stated otherwise.

Heat generated by the heating element 130 is transferred to surrounding layers of the structure 100 by thermal conduction. The waveguide 110 and the air layer 140 are thereby heated by operation of the heating element 130. The effective refractive indices of modes within the waveguide 110 are therefore modulated by operating the heating element 130.

The waveguide 110, comprising InGaAsP, has a first thermal conductivity of approximately 13 W/mK, and in other examples more generally the waveguide has a first thermal conductivity of between 10 and 100 W/mK. For example, the waveguide may comprise InP, which has a thermal conductivity of 68 W/mK. The air layer 140 has a second thermal conductivity of approximately 0.02 W/mK. The first thermal conductivity is greater than the second thermal conductivity. In other words, the waveguide 110 is a better conductor of heat than the air layer 140. Heat produced by the heating element 130 is therefore more readily transferred to the waveguide 110 than to the air layer 140. A greater portion of the heat is thereby transferred to the waveguide 110 than if the heating element 130 was in contact with the substrate 105, for example, improving the heating and power efficiency of the heating element 130.

Relative to the vertical axis 116, the air layer 140 has a first thickness and the heating element 130 has a second thickness. The second thickness is smaller than the first thickness. In the first examples, the first thickness is 1000 nanometres (nm) and the second thickness is 100 nm. However, in general, the first thickness can be at least 3 times larger than the second thickness. In this way, the air layer 140 is large relative to the heating element 130. This further reduces heat flow from the heating element 130 to the substrate 105, as the heating element 140 is closer to the waveguide 110, specifically the second cladding layer 111b, than to the substrate 105. The air layer 140 having a first thickness of more than 50 nm, or more than 100 nm, can reduce a risk that the air layer 140 is bridged by material during a deposition process during fabrication, for example. The air layer 140 being bridged by material, that is material connecting the heating element 130 to the substrate 105, can reduce heat insulation between the heating element 130 and the substrate 105 provided by the air layer 140.

Relative to the vertical axis 116, the first cladding layer 111a is thicker than the second cladding layer 111b. The heating element 130, which is positioned between the second cladding layer 111b and the substrate 105, is therefore closer to the core layer 111c than it would be if it were positioned above the first cladding layer 111a. This improves the heating performance of the heating element 130 as the heat is provided to the waveguide 110 more quickly, as it is transferred over a shorter distance.

The dielectric layer 131, comprising a dielectric material, is a poor electrical conductor. In other words, the dielectric layer 131 is electrically insulative. In the first examples, the dielectric layer 131 comprises aluminium oxide. The dielectric layer 131 reduces or prevents current flow within the metal layer 133 from interfering with the waveguide 110. For example, the dielectric layer 131 can prevent current from flowing into the waveguide 110 from the metal layer 133. This can prevent the waveguide 110 from providing electrical pathways for current which, for example, act to short circuit the metal layer 133 and thereby reduce heat generated by the metal layer 133. Preventing or reducing current flow in the in the waveguide 110 can also reduce or prevent the optical properties of the waveguide 110 from being impacted by electro-optic effects such as any of a Pockels effect, Kerr effect, or plasma and/or band-filling effects due to current from the metal layer 133.

The dielectric layer 131, comprising aluminium oxide, has a thermal conductivity of 30 W/mK in the first examples. More generally, the thermal conductivity may be between 1 and 10 W/mK, for example, and is large compared with the thermal conductivity of the air layer 140. In other examples, the dielectric layer 131 may comprise silicon oxide or silicon nitride. In selecting a dielectric layer 131 with a high thermal conductivity, the thermal performance of the heating element 130 can be maintained whilst the waveguide 110 is shielded electrically, as described above. Generally, the dielectric layer can have a thickness in the range of 10 to 50 nm such that the heating element 130 is relatively close to the waveguide 110, ensuring heating performance is maintained whilst shielding the waveguide 110 electrically.

As described above, the heating element 130 has a folded structure which at least partially wraps around a portion of the waveguide 110. The heating element 130, having such a folded structure, therefore has an increased surface area with which to emit heat to the waveguide 110, improving rate of heating of the waveguide 110. Additionally, the folded structure does not increase the lateral footprint of the heating element 130, relative to the horizontal axis 114 or length axis 118, improving the space efficiency of the PIC 10.

The heating element 130, which is between the waveguide 110 and the substrate 105, or in other words underneath the waveguide 110, is therefore less affected or substantially unaffected by layers deposited on top of the waveguide 110, such as passivation layers compared with, for example, a waveguide positioned between the heating element 130 and the substrate 105. For example, the heating effect may be less affected than with a heating element provided on top of a waveguide. The heating element 130 being substantially unaffected for example means that the heating element 130 produces the same heating effect on the waveguide 110 regardless of layers deposited on top of the waveguide 110, or the heating effect differs by a negligible amount for the desired purpose of the heating element 130. In this way, the heating performance of the heating element 130 can be independent of, or less affected by, packaging technology, or in other words the passivation layers, used for the PIC. The heating element 130, being provided between the waveguide 110 and the substrate 105, can therefore perform more consistently across PICs.

In the context of a suspended waveguide, the heating element 130 being provided between the waveguide 110 and the substrate 105, or in other words underneath the waveguide 110, means that the footprint of the structure 100 in a vertical direction is reduced, as the heating element 130 utilises existing space between the waveguide 110 and the substrate 105.

As noted above, the metal layer 133 may comprise or be platinum. Platinum is a noble metal, and can be more resistant to corrosion and oxidation than other types of metal. The metal layer 133 is therefore robust against deterioration due to, for example, oxidisation due to contact the air layer 140. This can improve the lifetime of the heating element 130. In other examples, other noble metals such as ruthenium, for example, could be used instead of or in addition to platinum.

The passivation layers, that is the first passivation layer 150 and the second passivation layer 155, may protect the waveguide 110, heating element 130 and air layer 140 from corrosion or otherwise being affected by the environment around the structure 100. The passivation layers 150, 155 can be thought of as shielding the structure 100, for example from moisture which may lead to corrosion. The first passivation layer 150, in being a boundary to the air layer 140, can also be considered to seal the air layer 140. The second passivation layer 155, which is closer to the waveguide 110, may be formed of a material or materials which have a reduced impact on the optical properties of the waveguide 110. The first passivation layer 150, which for example forms an external protective layer for the waveguide 110 and the second passivation layer 155, may be formed of a material or materials which are more resilient to an external environment of the structure 100 of PIC 10.

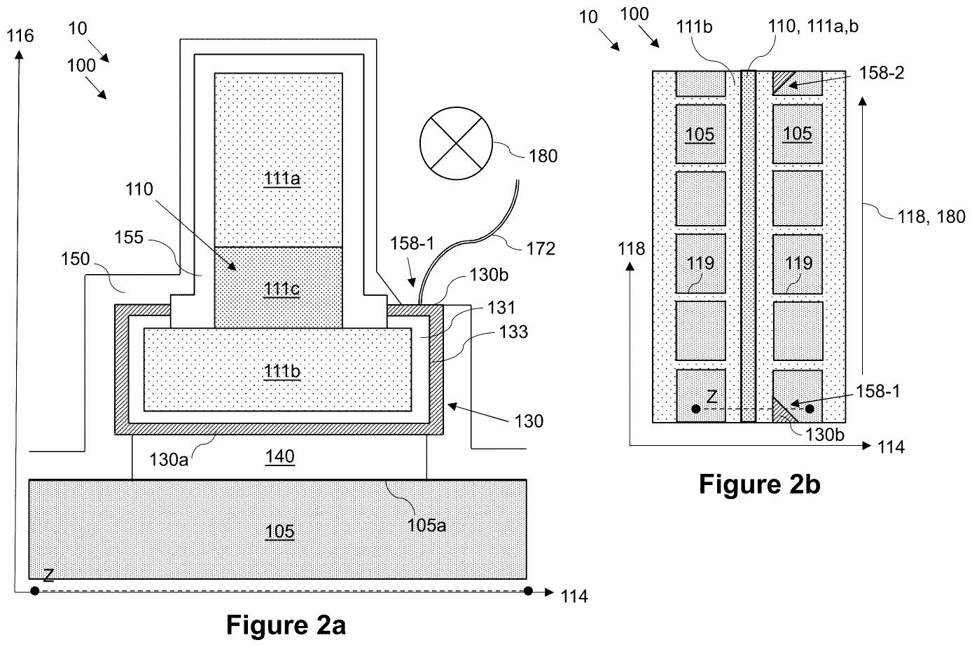

FIG. 2a illustrates schematically a cross-sectional view of the structure 100 of the first examples. FIG. 2b illustrates schematically the plan-view of FIG. 1b but with various different features labelled compared to FIG. 1b. The cross-section of FIG. 2a is taken along the line Z indicated in FIG. 2b. The cross-section Z is taken at a first end of the structure 100, with respect to the length axis 118.

At the section of the structure 100 illustrated in FIG. 2a, a first opening 158-1 is provided in the first passivation layer 150. The first opening 158-1 is triangular in shape, but in other examples may be a different shape. The second portion 130b of the heating element 130 is exposed by the first opening 158-1 in the first passivation layer 150 such that the metal layer 133 is exposed. An electrode 172, shown schematically in FIG. 2a, is electrically connected with the metal layer 133 at the second portion 130b of the heating element 130 via the first opening 158-1. A corresponding second opening, 158-2, in the first passivation layer 150 is provided at a second end of the structure 100, with respect to the length axis 118, to allow for electrical connection of a further electrode (not shown in FIG. 2b) with a portion of the metal layer 133 at the second end of the structure 100. Forming an electrical connection between the electrodes and the heating element 130 via the first opening 158-1 and second opening 158-2 allows the heating element 130 to be powered via a power source (not shown in FIGS. 2a and 2b). The power source, being electrically connected to the heating element 130 by the electrodes, applies an electrical potential, or voltage, across the heating element 130 to power, and thus heat, the heating element 130. Whilst the first portion 130a of the heating element 130 is underneath the waveguide 110, the heating element 130 having a second portion 130b provided above a portion of the waveguide 110 means the heating element 130 can be straightforwardly addressed via electrical contacts is formed from above, through the openings in the first passivation layer 150. This can reduce the spatial footprint of the structure 100 compared with, for example, providing electrical contacts laterally positioned with respect to the structure 100. Additionally, exposing the heating element 130 to the environment around the structure 100 at the first and second openings 158, 158-2 reduces the risk of damage to the heating element 130 compared to exposure of a greater extent of the heating element 130.

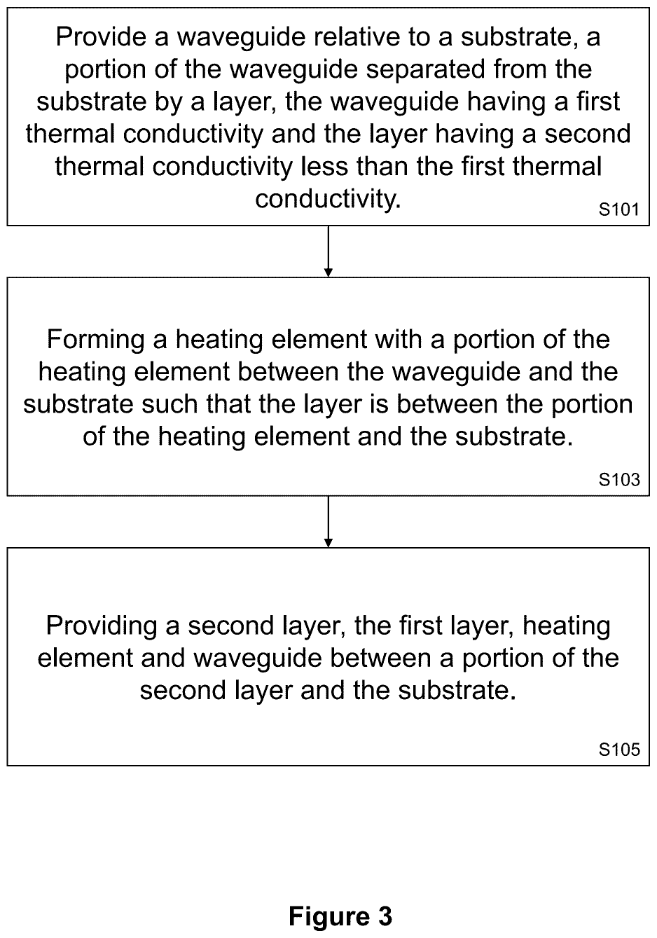

FIG. 3 is a flowchart illustrating an example method of fabricating the structure 100 of first examples.

At item S101, a waveguide is provided relative to a substrate. In a cross-sectional plane perpendicular to a light propagation axis of the waveguide at least a portion of the waveguide is separated from the substrate by a layer. The waveguide has a first thermal conductivity, and the layer has a second thermal conductivity less than the first thermal conductivity.

Item S101 may comprise fabricating such a waveguide, substrate and/or layer, or alternatively the waveguide, substrate and/or layer may have been fabricated previously, and item S101 represents a post-processing stage. As the skilled person will appreciate, various integrated photonic circuit fabrication techniques may be used to form the waveguide, layer, or substrate. For example, deposition, etching, and/or lithography may be used, and regrowth techniques such as metalorganic vapour-phase epitaxy (MOVPE) or molecular beam epitaxy (MBE) processes may be used. In some examples, the substrate material for the structure and/or photonic integrated circuit is InP. In some such examples, a wet etch procedure may be used in forming the waveguide and/or layer. In some such examples, a wet etch procedure is performed using HCl:H3PO4:H20. In some examples, a mixture of HCL, H3PO4 and H2O is used, which etches the desired material (in these examples, InP). In other examples, a mixture of HCL and H2O only is used as etchant. FeCl3 may also be used as an etchant. In examples, forming the waveguide and/or layer involves e.g. a dry etching procedure to remove material from either side of the structure, up to a particular depth as desired according to the intended application.

In examples, the layer is an air layer, for example when the waveguide has a suspended waveguide structure.

At item S103, a heating element is formed with a portion of the heating element between the waveguide and the substrate such that the layer is between the portion of the heating element and the substrate. In examples, forming the heating element comprises forming the heating element by atomic layer deposition. In examples, forming the heating element comprises forming a dielectric layer on the waveguide, and forming a metal layer on the dielectric layer. In some examples, the dielectric layer is formed by a first atomic layer deposition process and the metal layer is formed by a second atomic layer deposition process.

At item S105, a second layer is provided. In this way, the layer is a first layer, and the method further comprises forming a second layer such that the heating element and the first layer are between a portion of the second layer and the substrate. The second layer is, in examples, a passivation layer. In some examples, the second layer is an optical device such as an out-coupler. In some examples, item S105 does not occur, and the structure does not comprise a second layer.

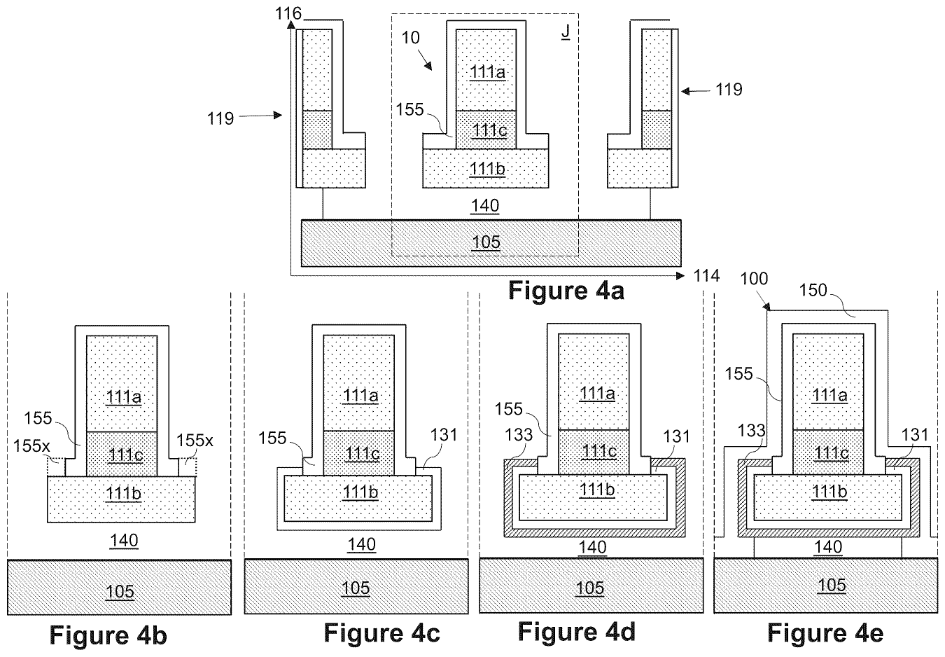

FIGS. 4a-e illustrate schematically an example method for forming the structure 100 of first examples in accordance with items 103-105 of FIG. 3. Specifically, FIGS. 4a-e illustrate schematically an example method for forming the heating element 130. Reference axes 114 and 116 are shown, as described for FIGS. 1a,b and 2a,b.

In FIG. 4a, a waveguide 110 comprising a core layer 111c, a first cladding layer 111a and a second cladding layer 111b is provided. The waveguide 110 is separated from a substrate 105 of a PIC 10 by a layer 140, in this example an air layer 140. A passivation layer 155 coats surfaces of the waveguide 110. Lateral support structures 119 are either side of the waveguide 110, the waveguide 110 having a suspended waveguide design. FIGS. 4b to 4e illustrate the structure within frame J, and therefore lateral support structures 119 are not illustrated in FIGS. 4b to 4e.

In FIG. 4b, portions 155x of the passivation layer 155 are removed from the top surface of the second cladding layer 111b. This can be achieved by an etching process, for example. In other examples, the passivation layer 155 may be fabricated in such a way that the passivation layer 155 is absent from portions of the top surface of the second cladding layer 111b, and such a removal step is not required.

In FIG. 4c, a dielectric layer 131 is formed. The dielectric layer 131 is formed by atomic layer deposition. The dielectric layer 131, being formed through atomic layer deposition, conforms to exposed surfaces of the second cladding layer 111b. The dielectric layer 131, being formed through atomic layer deposition, is substantially uniformly deposited such the dielectric layer 131 has uniform thickness. The dielectric layer 131 is substantially uniformly deposited to a thickness of, for example, 10 nanometres.

In FIG. 4d, a metal layer 133 is formed. The metal layer 133 is formed by atomic layer deposition. The metal layer 133, being formed through atomic layer deposition, conforms to exposed surfaces of the dielectric layer 131. The metal layer 133, being formed through atomic layer deposition, is substantially uniformly deposited such that the metal layer 133 has uniform thickness. The metal layer 133 is substantially uniformly deposited to a thickness of, for example, 50 nanometres.

The dielectric layer 131 and metal layer 133 being substantially uniformly deposited for example means that the layers are uniform within the fabrication tolerances of the respective atomic layer deposition process used. Substantially uniform can for example be uniform within 2-3 nanometres, or a few monolayers of material, such as less than 10 layers of material.

The skilled person will appreciate that, in examples, atomic layer etching can also be used to remove the dielectric layer 131 and/or the metal layer 133 as part of a refinement or modification process to achieve a specific desired structure of said layer, for example.

The heating performance of a heating element can be dependent upon the thickness of the constituent layers. For example, the resistance of the metal layer 133 is dependent upon the thickness of the metal layer 133 which can mean, for a given voltage, the heating produced by the metal layer 133 varies for different thicknesses. Variation in the thickness of the metal layer 133 can therefore result in inconsistent heating performance. Firstly, electrical properties of the first heating element 130 could be different to electrical properties of a second heating element if there is variation in the thickness of the respective metal layers, which can complicate control of the two heating elements. Secondly, the heating element 130 could have an inconsistent thickness along its length which could produce non-uniform heating and therefore produce a non-uniform optical effect in the waveguide 110. Similarly, variations in the thickness of the dielectric layer 131 can modify the transfer of heat to the waveguide 110. Producing the dielectric layer 131 and metal layer 133 by atomic layer deposition can improve uniformity of the respective layer thicknesses. This can improve the reliability and performance of the heating element 130.

Atomic layer deposition is conformal to a surface upon which a layer is being deposited. The heating element 130, being formed by atomic layer deposition onto the waveguide 110, can therefore conform to external surfaces of the waveguide 110. This can improve heating performance of the heating element 130 by reducing disconnections between the waveguide 110 and the heating element 130. The waveguide 110 is therefore not limited to, for example, simple planar geometries, but instead can be designed according to the intended application, and the heating element 130 can conform to the waveguide 110 due to atomic layer deposition technique.

It will be appreciated that fabrication steps involving atomic layer deposition may deposit material on the substrate 105, as well as the on surface of the structure 100. Such depositions may be inadvertent or unavoidable, for example. Similarly, structures according to examples may comprise material on the substrate 105. In examples illustrated by the figures and described herein, such material is not explicitly identified or labelled, but may nevertheless be present. In examples, additional steps may be performed to remove such material on the substrate 105. In further examples, material may remain on the substrate 105. In such examples, the material on the substrate 105 may remain because the material does not impact, or does not significantly impact, performance of the structure 100, or because impact on the performance is within acceptable tolerances, for example.

The first portion of the heating element 130a is formed between the substrate 105 and the waveguide 110, as illustrated by and described for FIG. 1a. The second portion of the heating element 130b is formed on the second cladding layer 111b of the waveguide in the space left by the portions 155x of the passivation layer removed in FIG. 4b.

In FIG. 4e, the passivation layer 155 becomes a second passivation layer 155 as a first passivation layer 150 is formed. The first passivation layer 150 substantially coats external surfaces of the waveguide 110, second passivation layer 155, heating element 130 and substrate 105. Deposition of the passivation layer 155 seals the air layer 140 such that the air layer 140 can be considered to be hermetically sealed. In general, passivation layers 150, 155 can be formed by techniques such as Plasma Enhanced Chemical Vapor Deposition (PECVD) and/or sputtering, for example.

FIG. 5 illustrates schematically a cross-section across the full width, relative to the horizontal axis 114, of the structure 100 and the PIC 10. The cross-section is taken along the line W of FIG. 1b. The lateral support structures 119 are shown either side of the structure 100. The passivation layer 150 forms a continuous, conformal layer across the structure 100 and the lateral support structures 119 to thereby protect the structure 100 and the lateral support structures 119.

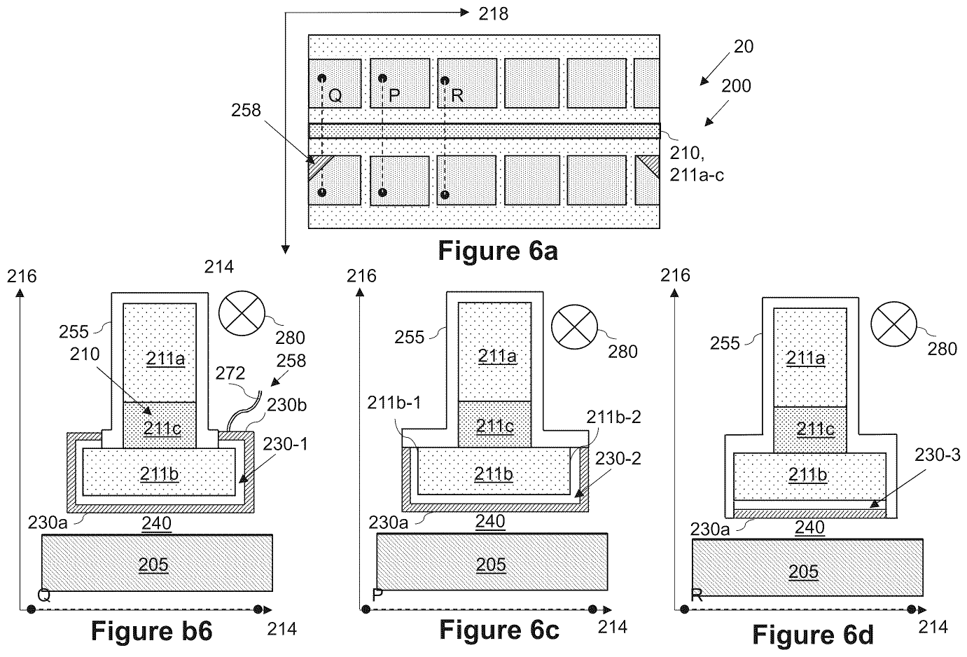

FIGS. 6a-d illustrate schematically a structure 200 for a PIC 20 according to second examples, the structure 200 and PIC 20 being displayed in plan-view (FIG. 6a) and three cross-sectional views (FIG. 6b-d). Reference integers provided for FIGS. 6a-d correspond to those provided for FIG. 1, but begin 2XX rather than 1XX; corresponding descriptions are to be taken to apply. For example, a set of reference axes 214 and 216 are otherwise identical to the vertical axis 116 and horizontal axis 114, respectively.

In the first examples, the structure 100 is substantially uniform along a length in the direction of the light propagation axis 180; that is, the structure 100 is for example identical (within fabrication tolerances) along its length, with the exception of the openings 158-1, 158-2, and in particular the heating element 130 for example has the same structural design throughout the length of the structure 100, again within fabrication tolerances. The structure 200 of the second examples, in contrast, is not uniform along a length in the direction of a light propagation axis 280, and in particular the structural design of the heating element 130 varies along the length of the structure 200.

The structure 200 of the second examples, as per the structure 100 of the first examples, comprises a substrate 205, a waveguide 210, a heating element 230 and a layer 240. The heating element 230 changes structure along a length of the structure 200 along the length axis 218, shown in FIG. 6a. A passivation layer 255 is present but not shown in FIG. 6a.

At a first cross-sectional section Q, illustrated by FIG. 6b, the heating element 230 is similar to the heating element 130 described in FIG. 1. The heating element 230-1 at section Q has a first portion 230a and a second portion 230b. The first portion 230a is located between the waveguide 210 and the substrate 205 and is separated from the substrate 205 by a layer 240. The second portion 230b is provided above the second cladding layer 211b. An opening 258 in the passivation layer (not shown) is present such that the second portion 230b of the heating element 230-1 is electrically contactable by an electrode 272.

At a second cross-sectional section P, illustrated by FIG. 6c the heating element 230-2 comprises the first portion 230a and extends along the left- and right-hand sides 211b-1, 211b-2 of the second cladding layer 211b but does not extend across a top surface of the second cladding layer 211b. In this way, the heating element 230-2 lacks the second portion 230b.

At a third cross-sectional section R, illustrated by FIG. 6d, the heating element 230-3 only comprises the first portion 230a, and does not contact the left or right sides of the second cladding layer or the top surface of the second cladding layer 211b.

The structure 200 of the second examples, having a varying cross-sectional structure along its length, may have improved performance. For example, the heating performance may be better when the heating element 230 is configured as per heating element 230-3, but more easily electrically contactable when configured as per heating element 230-1.

Intermediate sections (not illustrated here) between sections Q, P, and R, may provide transitions in structure between the illustrated portions of the structure 200.

The above examples are to be understood as illustrative examples. Further examples are envisaged.

In the above examples, the light propagation axis is substantially, for example within fabrication tolerances, straight and parallel to a length axis, and the structure accordingly straight and parallel to the length axis. In other examples, the structure may be curved, and the light propagation axis different to a length axis, such as not parallel to the length axis.

In some examples, the waveguide may comprise different arrangements of cladding layers, such as a third and a fourth cladding layer. In further examples, the waveguide may only comprise a core layer 111c.

In some examples, the air layer 140 may comprise other materials with a thermal conductivity lower than the waveguide 110. For example, the air layer 140 may instead be a vacuum layer or a gas layer comprising some other gas, such as nitrogen or argon. In further examples, non-gaseous materials with a thermal conductivity lower than the waveguide 110 may be provided as the air layer 140, for example oils, aerogels, other dielectric materials, or polymers. In such examples, the layer being surrounded by respective surfaces of the substrate, heating element and passivation layer (or equivalent other layer) means that the layer can be sealed to, for example, maintain a vacuum or prevent gas from escaping the layer.

Other metals than noble metals may be used in the heating element. For example, the air layer 140 may be a vacuum layer, so that there is a low risk of oxidation of the metal layer.

In the above examples, a passivation layer 150 is provided, substantially on top and around the waveguide 110, heating element 130 and air layer 140, to protect these components from the environment. In other examples, the structure may not comprise a passivation layer 150, and in some examples may instead or additionally comprise layers provided for other purposes. For example, structures for performing additional optical processes such as an out-coupler may be provided on top of the structure 100. In this way, the heating element 130 being beneath the waveguide 110 allows other optical component(s) to be provided above the waveguide 110 without the heating element 110 impacting the operation of the other optical component(s).

In the above examples, the heating element comprises a dielectric layer and a metal layer. In other examples, the heating element might only comprise a metal layer because, for example, the waveguide material is relatively unaffected by electrical current the impact of electrical current is negligible and/or tolerable for the desired application. In yet further examples, the heating element may comprise some other material than a metal layer. In still further examples, the heating element may comprise multiple metal layers and/or multiple dielectric layers. For example, the second portion of the heating element which is exposed and used to form an electrical contact may comprise a first metal which is resistant to exposure to the environment, whereas the first portion of the heating element may comprise a second metal which produces more effective heating, for example.

In the above examples, the waveguide is entirely separate from the substrate, excluding the lateral support portions of the suspended waveguide design. In other examples, only a portion of the waveguide may be separated from the substrate, such as an under-etched segment of the waveguide between the waveguide and the substrate. In such an example, the heating element is located in this under-etched segment.

In the second examples of FIGS. 6a-d, different structural designs of the heating element 230 are presented. Other examples of the structure may comprise any of these structures without necessarily varying along their respective lengths. That is, in other examples, a structure may comprise the structural design illustrated in the cross-section of FIG. 6c without varying along its length. Also, in other examples, a structure may comprise the structural design illustrated in the cross-section of FIG. 6d without varying along its length.

In the above examples, openings are provided at a first end and a second end and on a same side of the structure 100, 200. For example, in FIG. 1b the openings can be considered to be to the right-hand side of the structure 100. In other examples, other openings may be additionally or alternatively provided. For example, the openings could be located to the left-hand side of a structure. In further examples, openings may be provided on both sides of the structure. In yet further examples, a first opening at a first end may be provided on the left-hand side, and a second opening at the second end may be provided on the right-hand side, or vice versa.

In general, it is to be appreciated that the structure described herein is suitable for use in photonic devices, and in some examples the structure can be described as a photonic device. Similarly, the structure may be referred to as a photonic structure, for example where the structure forms a portion of a photonic device. The structure described herein is for example suitable for use in thermo-optic devices, and the structure may be alternatively referred to as a thermo-optic device. It is to be understood that, in providing control of the thermo-optic properties of a waveguide, the structure could be referred to as a thermo-optic control structure. The structure described herein could alternatively be described as a photonic component, and it is to be appreciated that a photonic component may form part of a larger photonic component.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A structure comprising:
a substrate;
a waveguide having a first thermal conductivity, and a light propagation axis;
a layer having a second thermal conductivity lower than the first thermal conductivity; and
a heating element operable to heat the waveguide and modify a refractive index of the waveguide, a portion of the heating element, in a cross-sectional plane perpendicular to the light propagation axis, located between the waveguide and the substrate, and separated from the substrate by the layer.

2. The structure of claim 1, wherein the layer is a gas layer or a vacuum layer.

3. The structure of claim 1, wherein the heating element is substantially entirely separated from the substrate by the layer.

4. The structure of claim 1 wherein, in the cross-sectional plane perpendicular to the light propagation axis and along a first axis having a direction from the substrate to the waveguide, the layer has a first thickness and the heating element has a second thickness smaller than the first thickness; or
wherein, in the cross-sectional plane perpendicular to the light propagation axis and along a first axis having a direction from the substrate to the waveguide, the layer has a first thickness and the heating element has a second thickness smaller than the first thickness, and the first thickness is at least 3 times larger than the second thickness.

5. The structure of claim 1, wherein the layer is a first layer, and the structure comprises a second layer, wherein in the cross-sectional plane perpendicular to the light propagation axis the waveguide, the heating element, and the first layer are located between a portion of the second layer and the substrate; or
wherein the layer is a first layer, and the structure comprises a second layer, wherein in the cross-sectional plane perpendicular to the light propagation axis the waveguide, the heating element, and the first layer are located between a portion of the second layer and the substrate and wherein the first layer is surrounded, in the cross-sectional plane perpendicular to the light propagation axis, by respective surfaces of the substrate, the heating element, and the second layer.

6. The structure of claim 5, wherein the second layer is a passivation layer.

7. The structure of claim 5, wherein the second layer comprises an opening, the heating element electrically contactable by an electrode through the opening for application of an electrical potential to the heating element.

8. The structure of claim 1, wherein the waveguide comprises:
a first cladding layer;
a second cladding layer; and
a core layer between and in contact with the first cladding layer and the second cladding layer, in the cross-sectional plane perpendicular to the light propagation axis.

9. The structure of claim 8, wherein the second cladding layer is between and in contact with the core layer and the heating element, in the cross-sectional plane perpendicular to the light propagation axis, and the first cladding layer is thicker than the second cladding layer along a first axis having a direction from the substrate to the waveguide.

10. The structure of claim 1, wherein the portion of the heating element is a first portion, the first portion of the heating element located at least partly between a second portion of the heating element and the substrate.

11. The structure of claim 10, wherein, in the cross-sectional plane perpendicular to the light propagation axis, a portion of the waveguide is located between the first portion of the heating element and the second portion of the heating element.

12. The structure of claim 10, comprising an electrode in electrical contact with the second portion of the heating element for application of an electrical potential to the heating element to heat the waveguide.

13. The structure of claim 1, wherein the heating element comprises:
a metal layer; and
a dielectric layer located between the waveguide and the metal layer.

14. The structure of claim 13, wherein at least one of:
(i) the dielectric layer comprises aluminium oxide, silicon nitride, or silicon oxide;
(ii) wherein the dielectric layer has a third thermal conductivity greater than 25 W/mk; and
(iii) the metal layer comprises ruthenium, platinum, or titanium.

15. The structure claim 1, wherein, in the cross-sectional plane perpendicular to the light propagation axis and along a second axis perpendicular to a direction from the substrate to the waveguide, the waveguide has a width and the portion of the heating element extends along a substantial portion of the width of the waveguide.

16. A photonic integrated circuit comprising the structure of claim 1.

17. A method of manufacturing a structure, the method comprising:
providing a waveguide relative to a substrate such that a portion of the waveguide, in a cross-sectional plane perpendicular to a light propagation axis of the waveguide, is separated from the substrate by a layer, the waveguide having a first thermal conductivity, and the layer having a second thermal conductivity less than the first thermal conductivity; and
forming a heating element with a portion of the heating element between the waveguide and the substrate such that the layer is between the portion of the heating element and the substrate.

18. The method of claim 17, wherein the layer is a gas layer or vacuum layer.

19. The method of claim 17, wherein at least one of:
(i) the forming the heating element comprises forming the heating element by atomic layer deposition; and
(ii) wherein the forming the heating element comprises:
forming a dielectric layer on the waveguide; and
forming a metal layer on the dielectric layer.

20. The method of claim 17, wherein the layer is a first layer, and the method further comprises forming a second layer such that the waveguide, the heating element and the first layer are located between a portion of the second layer and the substrate.
